(19) United States
(12) Patent Application Publication
(10) Pub. No.: US 2022/0358487 A1
(43) Pub. Date: Nov. 10, 2022

(54) SYSTEMS AND METHODS FOR PAYMENT OPTION CURATION

(71) Applicant: Credit Card Curator, LLC, Lakeville, CT (US)

(72) Inventors: John Taylor Garner, Lakeville, CT (US); Bruce Gordon Garner, Lakeville, CT (US); Sohel Roopani, Los Angeles, CA (US); Anuj Patel, Philadelphia, PA (US)

(21) Appl. No.: 17/738,211

(22) Filed: May 6, 2022

Related U.S. Application Data
(60) Provisional application No. 63/186,041, filed on May 7, 2021.

(51) Int. Cl. G06Q 20/34; G06Q 20/20; G06Q 20/12; G06Q 20/36; G06Q 20/40; G06Q 20/02

(52) U.S. Cl. CPC G06Q 20/3574; G06Q 20/20; G06Q 20/1235; G06Q 20/36; G06Q 20/4015; G06Q 20/02; G06Q 20/3572

(57) ABSTRACT

Various embodiments describe approaches for maximizing rewards associated with financial accounts for at least one user-defined goal (e.g., a travel benefit, a cashback benefit, a flight benefit, a hotel benefit, a charitable contribution benefit, a return benefit, etc.) For example, a user may submit a request for a portfolio of accounts (e.g., credit card accounts, checking accounts, savings accounts, a combination thereof) to achieve specific goals within a specified time given the user's spending habits, the number of credit card accounts desired, etc. Financial transaction information, reward program terms, banking institution policies, and the like can be obtained and analyzed to determine and present the portfolio of accounts, timing guidelines, and spending guidelines can be generated. Thereafter, rewards earned from purchases of goods and/or services made in accordance with the timing and spending guidelines maximize the rewards earned towards the user's goal for the specified period of time.

### CROSS-REFERENCE TO RELATED APPLICATIONS

This application claims priority to U.S. Provisional Patent Application Ser. No. 63/186,041, filed May 7, 2021, entitled SYSTEMS AND METHODS FOR PAYMENT OPTION CURATION, the entire contents of which are incorporated herein by reference.

### BACKGROUND

Many consumers have multiple credit cards, and each credit card can have a unique set of rewards based on purchase type, purchase place, amount spent, etc. In addition to this, many credit cards offer larger reward incentives with various reward structures (e.g., greater rewards for purchases for specific merchant categories, such as categories associated with travel or restaurants, greater rewards for using rewards with certain merchant or merchant categories, varying exchange rates for trading one reward for another, bonus rewards for spending a specified amount within a set period of time, etc.). All of this has made it much more complicated for a consumer to optimize for earning rewards and spending the rewards that they may have accumulated. Further, it can be difficult for a consumer to keep track of multiple credit cards. What is needed are techniques to automatically select an advantageous payment account and/or card based on a purchase context to optimize rewards.

### SUMMARY

Systems and methods in accordance with various embodiments describe real-time or near real-time systems and methods for payment option curation. Payment option curation in various embodiments can include determining and selecting a payment option (e.g., payment card, payment account, etc.) based on a purchase context (e.g., merchant, transaction amount, etc.) to optimize rewards by utilizing, e.g., a payment option curation account, transfer merchant codes, and the like.

In an example, a transaction indication can be received between a payment option curation account and a merchant. The payment option curation account may be associated with a physical payment card, such as a credit card or a debit card. In various embodiments, the payment option curation account may be associated with a virtual payment account and/or card. In an embodiment, a transaction (e.g., purchase transaction) can be initiated based on the transaction indication. Initiating the transaction can include using an identifier associated with a payment option that is issued by a payment network processor. The identifier may be associated with at least one other payment option associated with the payment network processor. The transaction may include a set of transaction between different entities as will be described further herein. A connection to the payment network processor can be executed and a merchant code from the payment network processor can be received. A payment option can be selected by using a payment optimization algorithm and the merchant code to identify an efficient and realistic way for a user of the payment option curation account to apply, transfer and accumulate the necessary rewards to accomplish a rewards-based goal. Thereafter, the transaction can be completed by applying the payment option.

Disclosed herein are devices for payment option curation. An example device may comprise a processor. The example device may comprise a memory storing instructions executable by the processor. The instructions may be configured to receive a transaction indication. The instructions may be configured to initiate a transaction based on the transaction indication by using an identifier associated with a credit card that is issued by a payment network processor. The identifier may be associated with at least one other payment option associated with the payment network processor. The instructions may be configured to connect to the payment network processor. The instructions may be configured to receive a merchant code from the payment network processor. The instructions may be configured to identify a payment option by using an optimization algorithm and the merchant code. The instructions may be configured to complete the transaction by applying the payment option.

Disclosed herein are computer readable non-transitory memory storing instructions executable by a processor for payment option curation. The instructions when executed may be configured to receive a transaction indication. The instructions when executed may be configured to initiate a transaction based on the transaction indication by using an identifier associated with a credit card that is issued by a payment network processor. The identifier may be associated with at least one other payment option associated with the payment network processor. The instructions when executed may be configured to connect to the payment network processor. The instructions when executed may be configured to receive a merchant code from the payment network processor. The instructions when executed may be configured to identify a payment option by using an optimization algorithm and the merchant code. The instructions when executed may be configured to complete the transaction by applying the payment option.

Embodiments provide a variety of advantages. For example, in accordance with various embodiments, real-time accumulation, exchange, and/or redemption of credit card rewards can be utilized by any system that attempts to optimize resources including computing system resources. The systems can include, for example, banking services, financial services, travel services, hotel services, flight services, and other electronic environments that allow a user to exchange reward points and other currency for products and services. In accordance with various embodiments, by providing a system that in real-time maximizes reward points across various credit cards, the system can more efficiently and quickly facilitate financial transactions, account creation, and other transactions. For example, financial transactions in accordance with approaches described herein are optimized for various digital payment systems, and thus more likely efficiently make use of computing system resources. Further, the amount of time, computing and other such resources used to earn rewards and spend the rewards they may have been accumulated can be decreased. Further still, resources and user preferences can be reasonably balanced in an expedient manner, which can reduce cost, system resources, and time in earning rewards, which based on conventional approaches may otherwise lead to a lengthy process requiring additional expenses, waste, and ultimately result in user's missing out on the largest pool of rewards that are typically offered by credit card providers—sign-up bonuses that are offered for enrolling with a credit card account. As such, conventional systems are less efficient and fail to effectively utilize resources, which results in a suboptimal distribution of resources.

Various other functions and advantages are described and suggested below as may be provided in accordance with the various embodiments.

This summary is provided to introduce a selection of concepts in a simplified form that are further described below in the Detailed Description. This summary is not meant or intended to identify or exclude key features or essential features of the claimed subject matter, nor is it intended to be used as an aid in determining the scope of the claimed subject matter.

In some aspects, the techniques described herein relate to a computing system, including: a computing device processor; and a memory device including instructions that, when executed by the computing device processor, enables the computing system to: receive a purchase transaction indication between a payment option curation account and a merchant, the purchase transaction indication associated with at least a merchant code and a transaction amount, the payment option curation account associated with a payment option curation card, initiate a first transaction based on the purchase transaction indication by using an identifier associated with the payment option curation account that is issued by a payment network processor, the identifier being associated with at least one other payment option, receive the merchant code from the payment network processor by using the purchase transaction indication, identify a set of payment options associated with the payment option curation account, select a payment option from the set of payment options by using an optimization algorithm and the merchant code to identify a selected payment option, complete the first transaction between the payment option curation account and the merchant, generate a transfer merchant code based on the merchant code, initiate a second transaction between the payment option curation account and the selected payment option based on the transaction amount and the transfer merchant code, and complete the second transaction between the payment option curation account and the selected payment option, wherein the first transaction is payable by the payment network processor and the second transaction is payable by a consumer associated with the selected payment option.

In some aspects, the techniques described herein relate to a computing system, wherein the first transaction is one of a point-of sale purchase transaction or a digital purchase transaction.

In some aspects, the techniques described herein relate to a computing system, wherein the purchase transaction indication is an indication from one of a credit card swipe, a credit card tap, a reading of a credit card chip, a near-field communication (NFC) chip, or a digital wallet.

In some aspects, the techniques described herein relate to a computing system, wherein the purchase transaction indication includes location data.

In some aspects, the techniques described herein relate to a computing system, wherein the location data indicates a proximity to the merchant.

In some aspects, the techniques described herein relate to a computing system, wherein the identifier is a primary account number (PAN).

In some aspects, the techniques described herein relate to a computing system, wherein individual payment options of the set of payment options includes a credit card number and an identifier associated with a third-party, the individual payment options being issued by a banking institution.

In some aspects, the techniques described herein relate to a computing system, wherein the merchant code includes one of a global merchant identifier or a proprietary merchant code created by the payment network processor.

In some aspects, the techniques described herein relate to a computing system, wherein the optimization algorithm uses machine learning to identify the selected payment option.

In some aspects, the techniques described herein relate to a computing system, wherein at least a portion of the optimization algorithm is executing on one of the payment option curation card, a blockchain environment, or a server.

In some aspects, the techniques described herein relate to a computing system, wherein the set of payment options includes one of a digital wallet, cryptocurrency wallet, a credit card account, a debit card account.

In some aspects, the techniques described herein relate to a computing system, wherein completing the second transaction includes one of using a primary account number (PAN associated with the selected payment option, deducting digital credit from a digital wallet, deducting cryptocurrency from a cryptocurrency wallet, deducting the transaction amount from a checking or savings account.

In some aspects, the techniques described herein relate to a computer-implemented method, including: receiving a purchase transaction indication between a payment option curation account and a merchant, the purchase transaction indication specifying at least a merchant code and a transaction amount, the payment option curation account associated with a payment option curation card, initiating a first transaction based on the purchase transaction indication by using an identifier associated with the payment option curation account that is issued by a payment network processor, the identifier being associated with at least one other payment option, receiving the merchant code from the payment network processor by using the purchase transaction indication, identifying a set of payment options associated with the payment option curation account, selecting a payment option from the set of payment options by using an optimization algorithm and the merchant code to identify a selected payment option, completing the first transaction between the payment option curation account and the merchant, generating a transfer merchant code based on the merchant code, initiating a second transaction between the payment option curation account and the selected payment option based on the transaction amount and the transfer merchant code, and completing the second transaction between the payment option curation account and the selected payment option, wherein the first transaction is payable by the payment network processor and the second transaction is payable by a consumer associated with the selected payment option.

In some aspects, the techniques described herein relate to a computer-implemented method, wherein the first transaction is one of a point-of sale purchase transaction or a digital purchase transaction.

In some aspects, the techniques described herein relate to a computer-implemented method, wherein the purchase transaction indication includes location data, and wherein the location data indicates a proximity to the merchant.

In some aspects, the techniques described herein relate to a computer-implemented method, wherein the purchase transaction indication is an indication from one of a credit card swipe, a credit card tap, a reading of a credit card chip, a near-field communication (NFC) chip, or a digital wallet.

In some aspects, the techniques described herein relate to a non-transitory computer readable storage medium storing instructions that, when executed by at least one processor of a computing system, causes the computing system to: receive a purchase transaction indication between a payment option curation account and a merchant, the purchase transaction indication specifying at least a merchant code and a transaction amount, the payment option curation account associated with a payment option curation card, initiate a first transaction based on the purchase transaction indication by using an identifier associated with the payment option curation account that is issued by a payment network processor, the identifier being associated with at least one other payment option, receive the merchant code from the payment network processor by using the purchase transaction indication, identify a set of payment options associated with the payment option curation account, select a payment option from the set of payment options by using an optimization algorithm and the merchant code to identify a selected payment option, complete the first transaction between the payment option curation account and the merchant, generate a transfer merchant code based on the merchant code, initiate a second transaction between the payment option curation account and the selected payment option based on the transaction amount and the transfer merchant code, and complete the second transaction between the payment option curation account and the selected payment option, wherein the first transaction is payable by the payment network processor and the second transaction is payable by a consumer associated with the selected payment option.

In some aspects, the techniques described herein relate to a non-transitory computer readable storage medium, wherein the instructions, when executed by the at least one processor, further enables the computing system to: analyze the purchase transaction indication to determine categories for anticipated purchases; and generate a list of preferred credit card accounts for use based on the categories for the anticipated purchases.

In some aspects, the techniques described herein relate to a non-transitory computer readable storage medium, wherein the instructions, when executed by the at least one processor, further enables the computing system to: determine a geographic location of the merchant; identify a business at which the first transaction is being undertaken based on the geographic location; and identify a payment option that maximizes rewards when used to complete the first transaction.

In some aspects, the techniques described herein relate to a non-transitory computer readable storage medium, wherein the merchant code includes one of a universal merchant code or a dynamic merchant code.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a user attempting to make a purchase in accordance with various embodiments.

FIG. 2 illustrates an example system for payment option curation to maximize the accumulation, exchange, and/or redemption of credit card rewards for using and/or exchanging the rewards for a specific purpose in accordance with various embodiments.

FIG. 3A illustrates an exemplary embodiment of a card engine in accordance with various embodiments.

FIG. 3B illustrates an exemplary embodiment of an optimization engine in accordance with various embodiments.

FIG. 4 illustrates an example environment for payment option curation in which aspects of the various embodiments can be implemented in accordance with various embodiments.

FIG. 5 illustrates process for payment option curation in accordance with various embodiments.

FIG. 6 illustrates an example process for completing a transaction in accordance with various embodiments.

FIG. 7 illustrates an example process for selecting a payment option to maximize the accumulation, exchange, and/or redemption of rewards in accordance with various embodiments

FIG. 8 illustrates components of a computing device that supports an embodiment of the present invention.

FIG. 9 illustrates an exemplary architecture of a system that supports an embodiment of the present invention.

FIG. 10 illustrates another exemplary architecture of a system that supports an embodiment of the present invention.

FIG. 11 illustrates components of a computer system that supports an embodiment of the present invention.

### DETAILED DESCRIPTION

The inventive system and method (hereinafter sometimes referred to more simply as “system” or “method”) described herein enable payment option curation. Specifically, the present invention enables initiation of a method to determine a preferred payment option based on a purchase and triggered by use of a credit card or other payment approach. More specifically, the present invention enables the use of points and/or rewards associated with multiple payment options, without the need to carry or manage the use of multiple payment options. The present invention enables the selection of a preferred payment option of the multiple payment options based on a purchase context. The present invention reduces the number of payment options a user needs to carry and the complexity of points and/or rewards systems associated with payment options a user needs to keep up with when picking a preferred payment option for a particular purchase.

The figures described herein generally illustrate an example approach to payment option curation that can be utilized in accordance with various embodiments. It should be understood that reference numbers are carried over between figures for similar components for purposes of simplicity of explanation, but such usage should not be construed as a limitation on the various embodiments unless otherwise stated.

It should be further noted that payment accounts can include credit card accounts, checking accounts, savings accounts, investment accounts, digital currency accounts, and the like. Reference to payment accounts is merely an example, and embodiments described herein apply to any combination of accounts, including credit card accounts, checking accounts, savings accounts, investment accounts, digital payment options, and the like.

Payment processes can comprise POS terminals, online checkouts or another online checkout process. Further, a physical card may be linked to an individual account. For example, a credit card may be linked to a credit card account, a debit card may be linked to a checking account, etc. A card can be used to make purchases, obtain cash, make deposits, view account balances, transfer funds, etc.

The term “payment option curation account” is used generally herein and throughout the specification for convenience but may more generally refer to a payment option associated with one or more other payment options. The payment option curation account can be a standalone payment account. The payment option curation account and associated payment options can include credit card accounts, checking accounts, savings accounts, investment accounts, digital currency accounts, and the like. The payment option curation account may be linked to a physical card. One or more payment options may be linked to a physical card. Individual cards and/or accounts can be used to make purchases, obtain cash, make deposits, view account balances, transfer funds, etc.

The term “transfer merchant code” is used generally herein and throughout the specification for convenience but may more generally refer to a merchant code used to complete a transaction while attempting to optimize rewards. In various embodiments, a transfer merchant code may be referred to as a dynamic list of merchant codes, transfer merchant code, a dynamic merchant code, and the like.

The term “credit card rewards” is used generally herein and throughout the specification for convenience but may more generally refer to rewards associated with using a financial instrument or for enrolling for an account that facilitates financial transaction, including, but not limited to (for example, a travel benefit, a cashback benefit, a flight benefit, a hotel benefit, a charitable contribution benefit, a return benefit, etc.).

The term “complex and dynamically changing goal” is used generally throughout the specification to refer to a goal that requires more than a few financial transactions to achieve and has a cost structure that may change frequently, in, for example, but not limited to, cash basis, rewards exchange basis, etc.

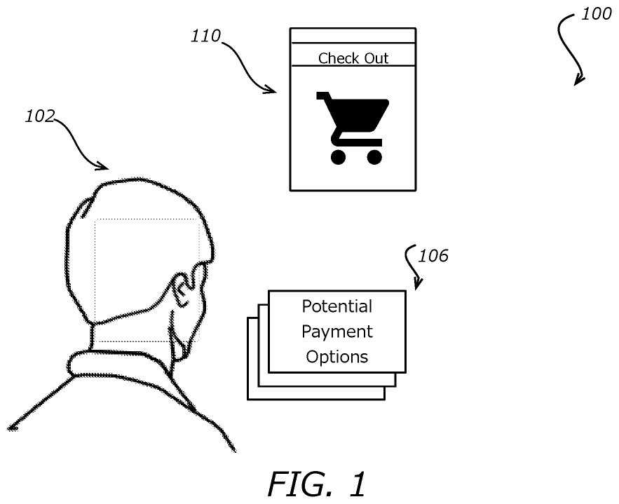

FIG. 1 illustrates example 100 of user 102 attempting to make a purchase with a computing device 110. Although a portable computing device (e.g., a smartphone, an e-book reader, or tablet computer) is shown, it should be understood that various other types of electronic devices having appropriate data processing capabilities that can be used in accordance with various embodiments discussed herein. These devices can include, for example, desktop computers, notebook computers, personal data assistants, cellular phones, video gaming consoles or controllers, smart televisions, wearable computers (e.g., smartwatches or glasses), and portable media players, among others. It should be further noted that although embodiments may be described with respect to online shopping, in which user 102 uses computing device 110 to make a purchase, embodiments herein are applicable to shopping in a physical location. In such embodiments, the computing device 110 may be a point-of-sale (POS) terminal and/or the user's computing device 110. As described in more detail below, geo-location data and user input data may be used in certain circumstances to identify the merchant and/or other details about the transaction that the user 102 would like to enter into.

In this example, user 102 is interested making a purchase. In order to make the purchase, the user can use one of a number of payment options, including, for example, credit card and bank cards 106. As described above, although credit and bank cards 106 are illustrated as physical cards in FIG. 1, the description herein is not limited to such cards and may include, for example, digital accounts that do not provide a physical card. User 102 has opened accounts for credit and bank cards 106 in part because the cards allow for the ability to earn rewards such as airline frequent flyer miles, hotel points, general use points, cash rebates, and other benefits with purchases. User 102, in this example, desires to earn enough rewards to redeem the rewards for a particular goal, e.g., a trip to Paris. However, because credit card and bank cards 106 have different reward structures, where some the cards provide greater rewards for purchases for specific merchant categories, user 102 is not sure which card to use to further their goal. In addition, at least some of the credit and bank cards 106 provide a bonus reward for spending a specified amount within a set period of time, but this information is not readily available and can be frustrating to track for each of the cards. Other factors that may be considered before making a purchase include, for example, the existence of a zero percent interest period for purchases for a particular card, the interest rate for a card for which the consumer may consider carrying a balance, the presence of an annual cap on the points that may be earned for a particular card, impact to credit score, probability of being approved for a particular card, and the like. As such, user 102 may default to a particular card to make the purchase and potentially miss out on maximizing rewards and reward bonuses.

Accordingly, in accordance with various embodiments, systems and methods in accordance with various embodiments describe real-time or near real-time systems and methods for maximizing the accumulation, exchange, and/or redemption of rewards for using and/or exchanging the rewards for a specific purpose, such as achieving a complex and dynamically changing goal. Specifically, embodiments determine a preferred payment option based on purchase context. More specifically, approaches enable the use of points and/or rewards associated with multiple payment options, without the need to carry or select from the payment options. Embodiments herein describe approaches for the selection of a preferred payment option based on a purchase context. The present invention reduces the number of payment options a user needs to carry and the complexity of points and/or rewards systems associated with payment options a user needs to keep up with when picking a preferred payment option for a particular purchase.

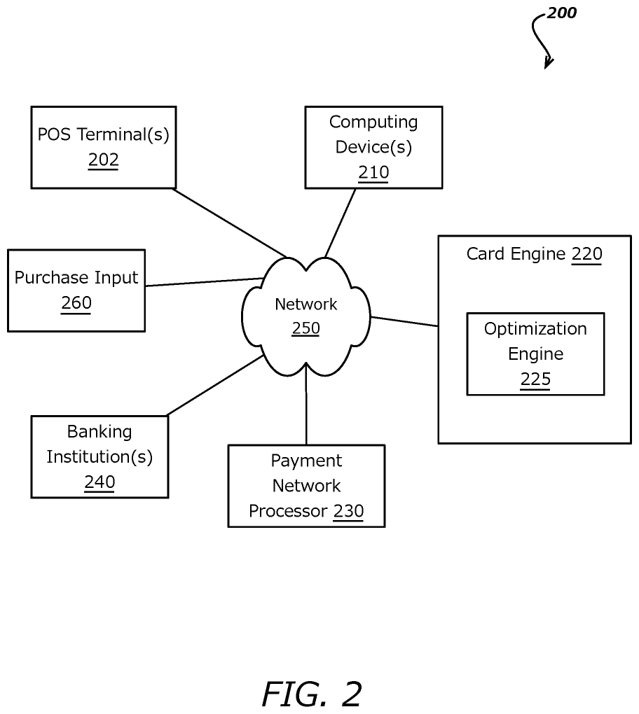

FIG. 2 illustrates an example system 200 for payment option curation to maximize the accumulation, exchange, and/or redemption of credit card rewards for using and/or exchanging the rewards for a specific purpose in accordance with various embodiments. It should be understood that reference numbers are carried over between figures for similar components for purposes of simplicity of explanation, but such usage should not be construed as a limitation on the various embodiments unless otherwise stated.

As shown, the environment may comprise POS terminal(s) 202, purchase input 260, banking institution(s) 240, payment network processor(s) 230, card engine 220, computing device(s) 210, and network 250. It should be known that the various systems and components described herein are exemplary and for illustration purposes only. The components may be reorganized or consolidated, as understood by a person of ordinary skill in the art, to perform the same tasks on one or more other servers or devices without departing from the scope of the invention. Other components may be used, as would be readily understood by a person of ordinary skill in the art, without departing from the scope of the embodiments described herein.

POS terminal(s) 202 may comprise any device to process payment. The POS terminal 202 may comprise a magnetic strip reader. The POS terminal 202 may comprise a chip reader. The POS terminal 202 may provide for contactless transactions; for example, the POS terminal 202 may comprise a camera for reading payment information (e.g., a Quick Response (QR) code, etc.). The POS terminal 202 may be configured to receive payment information from a mobile device.

The computing device(s) 210 may comprise a mobile device in communication with the POS terminal 202. The computing device(s) 210 may comprise a chip in a credit card. The computing device(s) 210 may comprise one or more laptops, desktops, mobile devices, etc. accessing an online store.

The computing device(s) 210 may be in communication with one or more of the POS terminal 202, one or more other computing device(s) 210, the card engine 220, the payment network processor 230, and/or the banking institution 240 via the network 250. The computing device(s) 210 (herein referred to as user input device, user device, or client device) may include, generally, a computer or computing device including functionality for communicating (e.g., remotely) over the network 250. Data may be collected from computing device(s) 210, and data requests may be initiated from each computing device(s) 210. Computing device(s) 210 may be a server, a desktop computer, a laptop computer, personal digital assistant (PDA), an in- or out-of-car navigation system, a smart phone or other cellular or mobile phone, or mobile gaming device, among other suitable computing devices. Computing device(s) 210 may execute one or more client applications, such as a web browser (e.g., Microsoft Windows Internet Explorer, Mozilla Firefox, Apple Safari, Google Chrome, and Opera, etc.), or a dedicated application to submit user data, or to make prediction queries over the network 250.

In particular embodiments, each computing device(s) 210 may be an electronic device including hardware, software, or embedded logic components or a combination of two or more such components and capable of carrying out the appropriate functions implemented or supported by the computing device(s) 210. For example and without limitation, computing device(s) 210 may be a desktop computer system, a notebook computer system, a netbook computer system, a handheld electronic device, or a mobile telephone. The present disclosure contemplates any user device as the computing device(s) 210. The computing device(s) 210 may enable a network user at the computing device(s) 210 to access network 250. The computing device(s) 210 may enable its user to communicate with other users at other computing device(s) 210.

The computing device(s) 210 may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. The computing device(s) 210 may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the computing device(s) 210 one or more Hyper Text Markup Language (HTML) files responsive to the HTTP request. The computing device(s) 210 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The computing device(s) 210 may also include an application that is loaded onto the computing device(s) 210. The application may obtain data from the network 250 and displays it to the user within the application interface.

This disclosure contemplates any suitable number of computing device(s) 210, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

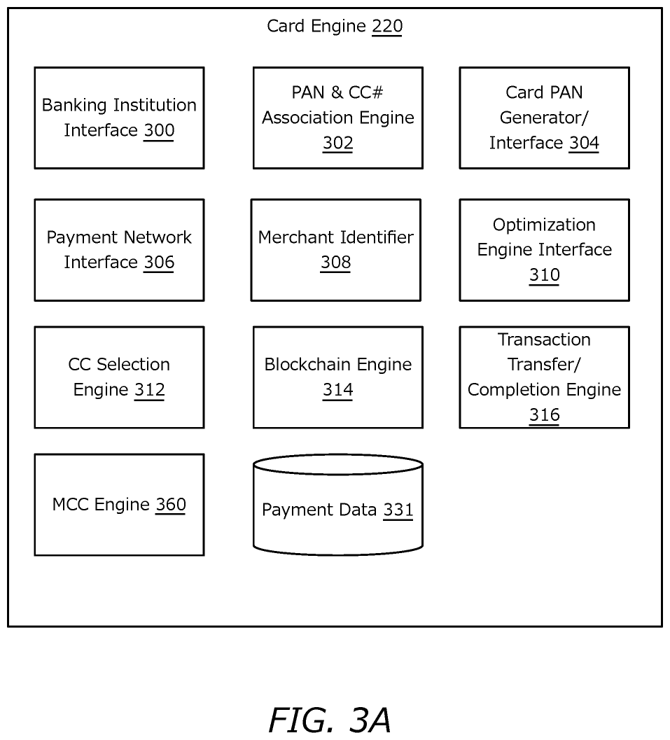

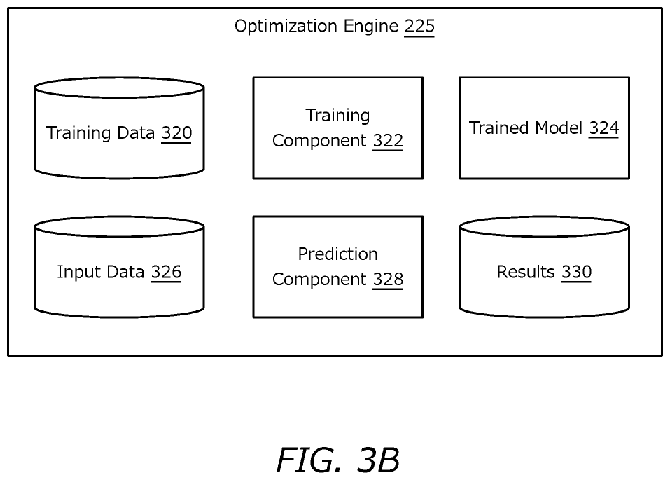

Card engine 220 may comprise an optimization engine 225. The card engine 220 and the optimization engine 225 will be described in more detail in reference to FIG. 3A and FIG. 3B. Although shown as a separate server connected to the network 250 in FIG. 2, in other embodiments, the card engine 220 and the optimization engine 225 may reside elsewhere in the environment. For example, the card engine 220 and the optimization engine 225 may reside, at least partially, in software in an application executing on the POS terminal(s) 202 and/or on a mobile device in communication with the POS terminal(s) 202. In another example, the card engine 220 and the optimization engine 225 may reside in a chip in a credit card. In this example, at least some of the functions of the card engine 220 and optimization engine 225 are executed in the firmware of the chip. In yet another example, at least some of the functions of the card engine 220 and optimization engine 225 are executed in the firmware of the chip and a remote server in communication with the chip. In another example, the card engine 220 and the optimization engine 225 may reside in software on a computing device (e.g., computing devices 210) accessing a merchant's online store. In another example, the card engine 220 and the optimization engine 225 may reside in the payment network processor 230. In another example, the card engine 220 and the optimization engine 225 may reside in a near-field communication (NFC) chip, a Wi-Fi chip, a Bluetooth chip, or the like, on a mobile device or a wearable device. In another example, card engine 220 and the optimization engine 225 may reside in code of a digital wallet. In yet another example, card engine 220 and the optimization engine 225 may execute in other contact chips like Bluetooth or WIFI. Card engine 220 and the optimization engine 225 may reside in any website digital wallet like via a browser extension.

The payment network processor 230 may comprise any computing device associated with any entity that provides networks for processing payments, such as credit card payments. The payment network processor 230 may be configured to perform any tasks required by the entity. The payment network processor 230 may issue credit cards. The payment network processor 230 may provide points and/or rewards associated with issued credit cards. The provided points and/or rewards may vary based on a particular card, transaction type, transaction amount, merchant, etc. The payment network processor 230 may issue curated credit cards. The payment network processor 230 may comprise and/or access a database comprising merchant codes. A merchant code (also known as a merchant category code, or MCC) includes, for example, a unique number or identifier that indicates a company's line of business and the types of goods or service the company provides. A universal merchant category code (also known as a universal merchant identifier, universal merchant code, global merchant code, and the like) includes a unique number or identifier that indicates a plurality of business types and types of goods or services that a company may provide. In an example, a universal merchant identifier includes all possible merchant codes. In another example, a universal merchant identifier includes a subset of all possible merchant codes. The universal merchant category code may also be referred to as a dynamic merchant code, a transfer merchant code, and the like.

The payment network processor 230 may receive payment information via the network 250 and process a transaction based on the payment information. The payment network processor 230 may process credit card transactions. The payment network processor 230 may process digital payment transactions. The payment network processor 230 may process crypto currency transactions. The payment network processor 230 may process prepaid card transactions. The payment network processor 230 may process gift card transactions.

Banking institution(s) 240 may comprise one or more computing devices in communication with the network 250. The banking institution 240 may issue credit cards. The banking institution 240 may provide points and/or rewards associated with issued credit cards. The provided points and/or rewards may vary based on a particular card, transaction type, transaction amount, merchant, etc.

Purchase input 260 is configured to receive a purchase transaction indication between a payment option curation account (e.g., a curated credit card) and a merchant or other entity receiving payment. In an embodiment, the purchase transaction indication includes a merchant code, a transaction amount, location data, etc. In various embodiments, the purchase transaction indication indicates a transaction and includes appropriate information for the transaction. In various embodiments, the location data can indicate a proximity of a purchaser to the merchant. The purchase transaction indication comprises, for example, an indication of the initiation of a purchase from one of a credit card swipe, a credit card tap, a reading of a credit card chip, a near-field communication (NFC) chip, or a digital wallet.

Network 250 may facilitate communication between the POS terminal 202, the computing device(s) 210, the card engine 220, the payment network processor, and the banking institution 240.

For example, a user may use a payment option curation account (also referred to as a curated credit card, a curated payment account, an intermediary credit card, a payment option curation card, and the like) issued by payment network processor 230 at a POS terminal 202 or at a merchant's online store via computing device(s) 210. In various embodiments, the payment option curation account is a virtual credit card and the POS terminal comprises on online checkout or another online checkout process.

The payment option curation card account may have a plurality of other associated payment options issued by banking institution 240. Each of the plurality of other associated payment options may have a points and/or rewards system.

In response to use of the payment option curation card, information associated with the payment option curation account may be transmitted across network 250 to card engine 220. In response to use of the payment option curation account, payment network processor 230 associated with the payment option curation account may receive an indication of the use via network 250. Card engine 220 may receive a merchant code relevant to the use of the payment option curation account from payment network processor 230 via network 250. Card engine 220 may use optimization engine 225 and the merchant code to determine at least one payment option of the other associated payment options. Card engine 220 may transmit information associated with the determined at least one payment option to payment network processor 230 via network 250 to complete the transaction initiated by the curated credit card.

The network 250 generally represents a network or collection of networks (such as the Internet or a corporate intranet, or a combination of both) over which the various components illustrated in FIG. 2 (including other components that may be necessary to execute the system described herein, as would be readily understood to a person of ordinary skill in the art). In particular embodiments, network 250 is an intranet, an extranet, a virtual private network (VPN), a local area network (LAN), a wireless LAN (WLAN), a wide area network (WAN), a metropolitan area network (MAN), a portion of the Internet, or another network 250 or a combination of two or more such networks 250. One or more links connect the systems and databases described herein to the network 250. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 250, and any suitable link for connecting the various systems and databases described herein.

The network 250 connects the various systems and computing devices described or referenced herein. In particular embodiments, network 250 is an intranet, an extranet, a virtual private network (VPN), a local area network (LAN), a wireless LAN (WLAN), a wide area network (WAN), a metropolitan area network (MAN), a portion of the Internet, or another network or a combination of two or more such networks 250. The present disclosure contemplates any suitable network 250.

One or more links couple one or more systems, engines or devices to the network 250. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 250.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to one or more computing device(s) or other devices in response to HTTP or other requests from one or more computing device(s) or other devices. A mail server is generally capable of providing electronic mail services to various one or more computing device(s) or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 2, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

The system may be reorganized or consolidated, as understood by a person of ordinary skill in the art, to perform the same tasks on one or more other servers or computing devices without departing from the scope of the invention.

FIG. 3A illustrates an exemplary embodiment of a card engine according to an embodiment. It should be known that the various components described herein are exemplary and for illustration purposes only. In this example, card engine 220 includes banking institution interface 300, PAN and credit card association engine 302, card and PAN generator/interface 304, payment network interface 306, merchant identifier 308, optimization engine interface 310, credit card selection engine 312, blockchain engine 314, transaction transfer/completion engine 316, and MCC engine 360. Other systems may be used, as would be readily understood by a person of ordinary skill in the art, without departing from the scope of the invention. Card engine 220 may also include or be in communication with one or more data stores, including, for example, payment data store 331.

It should be noted that although the data stores are shown as separate data stores, data from the data stores can be maintained across fewer or additional data stores. The data stores can be accessed by each of the various components in order to perform the functionality of the corresponding component. Other components, systems, services, etc. may access the data stores. Although card engine 220 is shown as a single system, the system may be hosted on multiple server computers and/or distributed across multiple systems. Additionally, the components may be performed by any number of different computers and/or systems. Thus, the components may be separated into multiple services and/or over multiple disparate systems to perform the functionality described herein.

Banking institution interface 300 may receive messages originated by a computing device associated with the banking institution 240 via a messaging protocol and prepare the messages in a manner suitable for consumption by the card engine 220. The banking institution interface 300 may receive information in a format usable by the card engine 220 and prepare the messages in a suitable messaging protocol to be ultimately consumed by a computing device associated with the banking institution 240. The banking institution interface 300 may send and/or receive messages across a network, such as the network 250. The banking institution interface 300 may send and/or receive messages arranged according to any standard, such as, Internet Protocol (IP), Wi-Fi, Bluetooth, etc.

PAN and credit card association engine 302 may link PANs associated with curated payments options such as curated credit cards with associated payment option information. Associated payment option information may comprise credit card information (e.g., PANs, personal identification numbers (PINs), bank identification numbers (BINs), smart routing (such as Unified Payments Interface (UPI)) information, expiration dates, etc.), digital wallet information (e.g., accounts, emails, passwords, etc.), crypto currency wallet information (e.g., addresses, private keys, public keys, etc.), and the like.

Card and PAN generator/interface 304 may generate a PAN for a curated credit card. The generated PAN may be for an associated curated credit card; however, the curated credit card may have no actual account itself, but rather by linked to a plurality of other credit cards and/or payment options. The card PAN generator and/or interface 304 may receive messages originated by the payment network processor 230, a computing device associated with the banking institution 240, and/or any computing device that may generate and/or use a PAN via a messaging protocol and prepare the messages in a manner suitable for consumption by the card engine 220. The card PAN generator and/or interface 304 may receive information in a format usable by the card engine 220 and prepare the messages in a suitable messaging protocol to be ultimately consumed by the payment network processor 230, a computing device associated with the banking institution 240, and/or any computing device that may generate and/or use a PAN. The card PAN generator and/or interface 304 may send and/or receive messages across a network, such as the network 250. The card PAN generator and/or interface 304 may send and/or receive messages arranged according to any standard, such as, Internet Protocol (IP), Wi-Fi, Bluetooth, etc.

Payment network interface 306 may receive messages originated by the payment network processor 230 via a messaging protocol and prepare the messages in a manner suitable for consumption by the card engine 220. The payment network interface 306 may receive information in a format usable by the card engine 220 and prepare the messages in a suitable messaging protocol to be ultimately consumed by the payment network processor 230. The payment network interface 306 may send and/or receive messages across a network, such as the network 250. The payment network interface 306 may send and/or receive messages arranged according to any standard, such as, Internet Protocol (IP), Wi-Fi, Bluetooth, etc.

Merchant identifier 308 may comprise a first list of merchant codes (e.g., MCC). In an embodiment, the merchant identifier 308 may comprise a map or information for mapping the first list of merchant codes to a second list of merchant codes compatible with a payment network processor 230 and/or vice versa. The first list of merchant codes may be a universal or standardized list of merchant codes. The merchant identifier 308 may use location data, such as Global Positioning System (GPS) coordinates, to determine a merchant.

MCC engine 360 may generate merchant codes, tag merchant codes, or otherwise manage merchant codes such as by adding, removing, tagging, or organizing merchant codes. In an embodiment, MCC engine 360 can generate a dynamic list of merchant codes. A dynamic list of merchant codes can include, for example, a list of merchant codes that updates based on purchase context or based on other information associated with a transaction. In an example, the dynamic list of merchant codes may be updated to add a merchant code used in a transaction between a payment option curation account and a merchant. In another example, a merchant code in the dynamic list of merchant codes may be associated with one or more of a time attribute, a use attribute, a transfer attribute creating, for example, a time-based merchant code, a use-based merchant code, or a transfer merchant code. When the tag is detected, a previously used merchant code may be available for use for a period of time, a specific use, and/or a determined number of subsequent uses. In an embodiment, the subsequent uses may be restricted to related transactions, such as a transfer transaction as described herein. The specific use may include transfer transactions.

In certain embodiments, MCC engine 360 can generate a global merchant code. A global merchant code includes, for example, a merchant code that includes all or at least more than one merchant code. In an example, a global merchant code may correspond to a set of merchant codes corresponding to multiple goods and services provided by merchants.

In an embodiment, MCC engine 360 may comprise appropriate systems and components to create entities such as a company, where each company can be associated with one or more merchant codes. For example, MCC engine 360 receive messages originated by entities operable to facilitate company formation via a communication bus and prepare responses in a manner suitable for consumption by the entities. MCC engine 360 can generate merchant codes and update the list of merchant codes. It should be noted that any one of a number of techniques may be utilized to generate or otherwise obtain a merchant code. In an embodiment, a company may be associated with one or more merchant codes.

Optimization engine interface 310 may receive messages originated by the optimization engine 225 via a communication bus and prepare the messages in a manner suitable for consumption by other components of the card engine 220. The optimization engine interface 310 may receive information in a format usable by other components of the card engine 220 and prepare the messages in a manner suitable for a communication bus and ultimate consumption by the optimization engine 225.

Credit card selection engine 312 may interpret results from the optimization engine 225. The credit card selection engine 312 may retrieve relevant information for a selected credit card consistent with the results from the optimization engine 225. Relevant information may comprise a PAN, a PIN, a BIN, smart routing (such as UPI) information, an expiration date, a billing address, a name, etc. The credit card selection engine 312 may retrieve relevant information for a selected payment option consistent with the results from the optimization engine 225. Relevant information may comprise an account, an email, a password, a digital address, a private key, a public key, etc.

Blockchain engine 314 may comprise a wallet for storage of currency, such as a crypto currency. The blockchain engine 314 may comprise software for maintaining a blockchain. The blockchain engine 314 may comprise a miner. The blockchain engine 314 may comprise a node with a wallet with a threshold amount of currency staked in the wallet.

Transaction transfer/completion engine 316 may complete a transaction (e.g., a transfer transaction) with information provided by the credit card selection engine 312. The transaction may be initiated by a PAN of a curated credit card, including, for example, a payment option curation account. The transaction may be recorded and completed using the information provided by the credit card selection engine 312 about the payment option selected by the optimization engine 325.

In certain embodiments, a curated credit card comprises a unique transaction code that can be assigned to each transaction. In this example, the transaction may be initiated by a PAN of a curated credit card. The transaction may be recorded and completed using the information provided by the credit card selection engine 312 about the payment option selected by the optimization engine 325. Continuing with this example, for each transaction a cryptographic token or other such token can be created through blockchain that can be used to immediately pays for the transaction. Thereafter, the transaction can be completed via the payment option selected by the optimization engine 325. In any such situation, from a user's perspective, each transaction with the curated credit card may be the same. However, the modules of the card engine 220 and the optimization engine 325 may complete the transaction with a particular payment option that will be advantageous to the user for the particular transaction.

FIG. 3B illustrates exemplary embodiment of optimization engine 225 according to an embodiment. It should be known that the various components described herein are exemplary and for illustration purposes only. In this example, optimization engine 225 may comprise a training module 322, a trained model 324, and a prediction module 328. Other systems may be used, as would be readily understood by a person of ordinary skill in the art, without departing from the scope of the invention.

Optimization engine 225 may also include or be in communication with one or more data stores, including, for example, training data store 320, input data store 326, results data store 330. It should be noted that although the data stores are shown as separate data stores, data from the data stores can be maintained across fewer or additional data stores. The data stores can be accessed by each of the various components in order to perform the functionality of the corresponding component. Other components, systems, services, etc. may access the data stores. Although optimization engine 225 is shown as a single system, the system may be hosted on multiple server computers and/or distributed across multiple systems. Additionally, the components may be performed by any number of different computers and/or systems. Thus, the components may be separated into multiple services and/or over multiple disparate systems to perform the functionality described herein.

In an embodiment, optimization engine 225 can generate a recommendation for one or more payment accounts to achieve specific goals given the user's spending habits, the number of payment accounts desired, etc. In an example, optimization engine 225 may obtain the merchant information from merchant identifier 308 and may recommend one or more payment accounts for a purchase transaction to achieve a goal that the user would like to accomplish based on input data including, for example, goals data, historic data, the reward policy data, accumulated rewards data, training data, and merchant data.

Goals data comprises a goal for a travel benefit, a cashback benefit, a flight benefit, a hotel benefit, a charitable contribution benefit, return benefit, investment benefit to an investment account, a digital currency benefit (e.g., a cryptocurrency investment benefit), a gift card benefit, a green benefit (e.g., a combination of investing and charity, including green investing, green charities, carbon credit, etc.), and the like. The goals may in certain embodiments may specify hotel room types, the desired number of hotel rooms, the number of nights for the hotel room; a rental car type, the number of rental cars, the number of days of renting the rental car; any specific brick and mortar store, online shopping store, or company, etc. In certain embodiments, goals from different users may be considered in the recommendation, where the different users may be provided a portfolio of recommended credit card accounts to achieve their specific goals, which may be used to satisfy the combined goals of the group.

Historic data comprises financial transaction information associated with a user, where the financial transaction information can include past purchase transaction information from one or more financial accounts (e.g., credit card accounts, checking accounts, savings accounts, etc.) associated with the user, reward points associated with reward programs associated with the user, past and/or current account card portfolios, and the like.

Reward policy data comprises reward program terms for a plurality of reward programs. A variety of different methodologies may be used to retrieve the relevant reward policy data, including but not limited to, data scrapes, API access, etc. The reward programs can be associated with a credit card account, checking account, saving account, etc., and a reward program can specify, for example, a reward program bonus, an amount to spend within a time frame to receive the reward program bonus, the number of miles required to travel to specific locations for various flight statuses, the number of points to stay at a hotel for different number of nights and rooms, the conversion or transfer of reward points from banks or other travel programs such as hotels and other airlines into miles or hotel points, and any other appropriate qualifying information. The various requirements of reward policy data may be categorized in a database. The credit card accounts, in certain embodiments, can be associated with banking institution policies that specify eligibility requirements for qualifying for a credit card account.

Accumulated rewards data can include an existing rewards balance with one or more reward programs, including, for examples, rewards from credit cards, airlines, hotels, merchants, and the like. In certain embodiments, as rewards are accumulated, for example, through use of credit cards associated with these rewards, hotel and/or airline miles earned, etc.

Merchant data comprises geo-location data and other data to identify a merchant and/or other details about a transaction that a user would like to enter into.

The input data 326 may comprise data relevant to a transaction. The input data 326 may comprise a merchant code, a purchase type, a purchase amount, a time, a date, payment options, associated point and/or reward information associated with each payment options, points and/or rewards redeemed, reward redemption options, points and/or rewards accumulated, etc.

The training data 320 may comprise historical data. The training data 320 may comprise information regarding past purchases (e.g., dates, amounts spent, etc.). The training data 320 may comprise information regarding past point and/or reward redemption (e.g., what was offered, what was redeemed, etc.). The training data 320 may comprise information regarding past point and/or reward accumulation (e.g., how many points and/or rewards were accumulated for particular transactions, how many points and/or rewards were accumulated for particular payment options used, etc.)

The optimization engine 225 may use machine learning. The optimization engine 225 may use artificial intelligence. The optimization engine 225 may be concerned with spending history. The optimization engine 225 may be concerned with point and/or reward redemption history. The optimization engine 225 may be concerned with getting the most points and/or rewards possible. For example, the training module 322 may train the trained model 324 using the one or more of training data 320, goals data, historic data, the reward policy data, accumulated rewards data, and merchant data depending on a particular concern or goal. In an example, the training module 322 may use information regarding past purchases to train the trained model 324. In another example, the training module 322 may use information regarding past point and/or reward redemption to train the trained model 324. In yet another example, the training module 322 may use information regarding past point and/or reward accumulation to train the trained model 324. Accordingly, the trained model 324 may model purchase behavior. The trained model 324 may model points and/or rewards redemption behavior. The trained model 324 may model points and/or rewards accumulation.

The trained model 324 may be used by the prediction module 328 to make payment option selection. For example, the prediction module 328 may use the trained model 324 and the input data 326 to predict results 330. The results 330 may comprise a particular payment option predicted to produce a desirable reward. For example, if prediction module 328 determines that a particular payment option offers the most rewards a user can get for a transaction, and those rewards relate to air miles, but the user does not ever redeem air miles, the prediction module 328 may select a different payment option. The results 330 may comprise a particular payment option predicted to produce the most points and/or rewards. In an example, when a purchase is contemplated, prediction module 328 may score each payment option with respect to the purchase and either recommend the highest scoring payment option or simply select the highest scoring payment option for the purchase, depending on consumer preferences. In certain embodiments, details of a user's location (e.g., geographic location or GPS location) can be used to identify nearby stores, which can be used to supplement details of a current purchase and/or otherwise be used to select a payment option for a purchase. In the situation a payment option is not included in the portfolio would be useful to maximize rewards for at least one goal or reward criterion, a notification or other information can be provided to the user, where the information can include details about the card, rewards missed for not using the card, updated timing and spending information should the card be added to the portfolio, and the like.

In an embodiment, the input data 326 and the results 330 may be used as future training data, creating a feedback loop that continually updates the trained model 324.

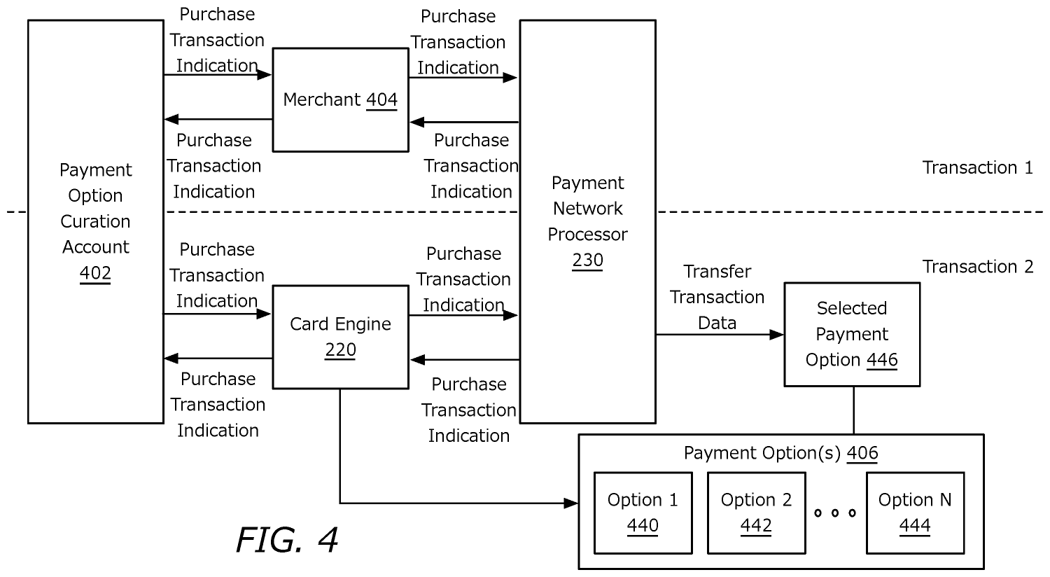

FIG. 4 illustrates an example environment for payment option curation in which aspects of the various embodiments can be implemented in accordance with an embodiment. In this example, a purchase indication for a transaction (e.g., a purchase transaction, a financial transaction, etc.) may be received by merchant 404. The purchase transaction may be between a user of payment option curation account 402 and merchant 404. In an embodiment, the transaction indication may specify a merchant code and a transaction amount.

Payment option curation account 402 may be associated with a plurality of other associated payment options 406 issued by a banking institution. For example, the plurality of payment options 406 can include payment option 440, payment option 442, payment option 444. Each of the plurality of other payment options may have a points and/or rewards system. The payment option curation account 402 and associated payment options can include credit card accounts, checking accounts, savings accounts, investment accounts, digital currency accounts, and the like. The payment option curation account may be linked to a physical card. One or more payment options may be linked to a physical card. Individual cards and/or accounts can be used to make purchases, obtain cash, make deposits, view account balances, transfer funds, etc.

A transaction may be initiated based on the transaction indication by using an identifier associated with payment option curation account. The transaction may be for the purchase of goods and/or services offered by the merchant. In an embodiment, the transaction indication includes a merchant code, a transaction amount, location data, etc. In various embodiments, the location data can indicate a proximity of a purchaser to the merchant. The transaction indication comprises, for example, an indication of the initiation of a purchase from one of a credit card swipe, a credit card tap, a reading of a credit card chip, a near-field communication (NFC) chip, or a digital wallet.

The merchant identifier may be issued by a payment network processor 230. In an embodiment, the merchant identifier may comprise a first list of merchant codes (e.g., MCC). In an embodiment, the merchant identifier may comprise a map or information for mapping the first list of merchant codes to a second list of merchant codes compatible with a payment network processor 230 and/or vice versa. The first list of merchant codes may be a universal or standardized list of merchant codes. The merchant identifier may comprise a proprietary merchant code created by the payment network processor 230. In an embodiment, the merchant identifier may comprise a global merchant category code. A global merchant category code (also known as a global merchant identifier or global merchant code) includes a unique number or identifier that indicates a plurality of business types and types of goods or services that a company may provide. In an example, a global merchant identifier includes all possible merchant codes. In another example, a global merchant identifier includes a subset of all possible merchant codes.

A first transaction may be executed between the payment option curation account 402 and the merchant 404. The first transaction may be executed in accordance with financial transaction guidelines, systems, and procedures known to those skilled in the art.

A second transaction (e.g., a transfer transaction) between payment option curation account 402 and one of the payment options can be initiated based on the context of the transaction. This can include, for example, the transaction amount, a transfer merchant code, and/or other factors described herein. For example, card engine 220 can receive the purchase transaction indication. Card engine 220 can generate or otherwise obtain a transfer merchant code based on the merchant code. In an example, a transfer merchant code may be received from the payment network processor 230. The merchant code may comprise a proprietary merchant code created by the payment network processor. The payment option curation account may have a first set of merchant codes stored in a database and may map the first set of merchant codes to a second set of merchant codes owned by the payment network processor. The second set of merchant codes may comprise the merchant code. In an embodiment, the merchant code may comprise a global merchant category code or transfer MMC. A global merchant category code (also known as a global merchant identifier or global merchant code) includes a unique number or identifier that indicates a plurality of business types and types of goods or services that a company may provide. In an example, a global merchant identifier includes all possible merchant codes. In another example, a global merchant identifier includes a subset of all possible merchant codes.

A payment option (e.g., one of payment options 440. 442. And 444) from the plurality of payment options 406 may be selected using an optimization algorithm and the merchant code. The payment option may be selected from the set of payment options 406. The optimization algorithm may use machine learning to identify the payment option. The optimization algorithm may use artificial intelligence to identify the payment option.

The second transaction is completed between the payment option curation account and the selected payment option 446, wherein the first transaction is payable by the payment network processor and the second transaction is payable by a consumer associated with the selected payment option.

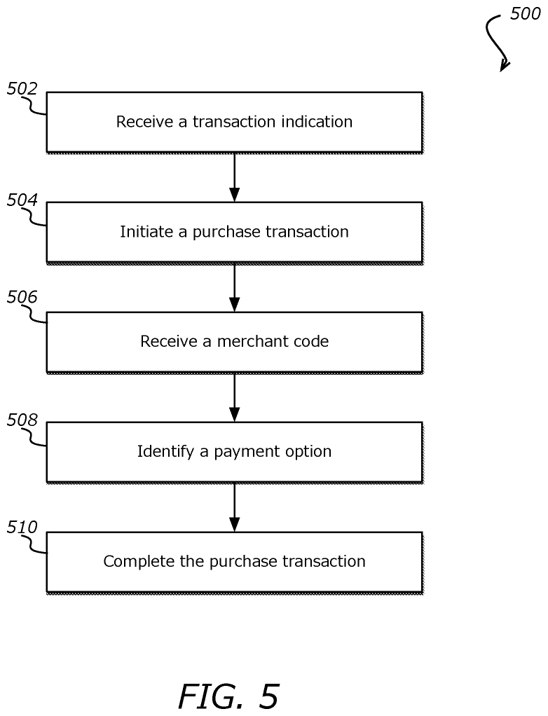

FIG. 5 illustrates an example process 500 for payment option curation in accordance with various embodiments. It should be understood that there can be additional, fewer, or alternative steps performed in similar or alternative orders, or in parallel, within the scope of the various embodiments unless otherwise stated. In embodiments, the method steps or techniques depicted and described herein can be performed in a processor of the point-of-sale terminal 202, the method steps being encoded as processor-executable instructions in a non-transitory memory of the point-of-sale terminal 202. In embodiments, the method steps or techniques depicted and described herein can be performed in a processor the computing device(s) 210, the method steps being encoded as processor-executable instructions in a non-transitory memory of the computing device(s) 210. In embodiments, the method steps or techniques depicted and described herein can be performed in a processor of the card engine 220, the method steps being encoded as processor-executable instructions in a non-transitory memory of the card engine 220. In embodiments, the method steps or techniques depicted and described herein can be performed in a processor of the payment network processor 230, the method steps being encoded as processor-executable instructions in a non-transitory memory of the payment network processor 230. The techniques of FIG. 5 may be implemented in an operating system kernel, in a separate user process, in a library package bound into network applications, on a specially constructed machine, on an application-specific integrated circuit (ASIC), or a field programmable gate array (FPGA).

A transaction indication for a purchase transaction may be received 502. The purchase transaction may be between a payment option curation account, for example, a curated credit card. The transaction indication may specify a merchant code and a transaction amount. In an embodiment, the curated credit card can be a virtual credit card and the POS terminal comprises on online checkout or another online checkout process. The curated credit card may have a plurality of other associated payment options issued by a banking institution. Each of the plurality of other associated payment options may have a points and/or rewards system. The transaction indication may be an indication of at least one of a credit card swap, a credit card tap, a reading of a credit card chip, and any method of consuming numbers associated with a credit card. The transaction indication may comprise location data. The location data may indicate a proximity to a merchant. The transaction indication may comprise an indication from a near-field communication (NFC) chip. The transaction indication may comprise an indication from a digital wallet. The transaction indication may comprise an indication from an online payment portal or online payment service.

A purchase transaction may be initiated 504 based on the transaction indication by using an identifier associated with a credit card that is issued by a payment network processor. The identifier may be associated with at least one other payment option associated with the payment network processor. The transaction may be a point-of-sale credit card purchase. The identifier may be a primary account number (PAN). The identifier may be associated with at least one other payment option associated with the payment network processor. The at least one other payment option associated with the payment network processor may comprise at least one credit card. The identifier may be associated with at least one other payment option not associated with the payment network processor. The at least one other payment option not associated with the payment network processor may comprise at least one of a digit wallet and a cryptocurrency wallet. The credit card may be associated with a plurality of other credit cards. Each of the plurality of other credit cards may comprise a credit card number and an identifier associated with a third-party. Each of the plurality of other credit cards may be issued by a banking institution. The third-party may not be the same as the banking institution. The third-party may be the same as the banking institution. The payment network processor may have issued the credit card. A credit card curator may create the credit card.

In an embodiment, the payment network processor may be connected to any computing device associated with any entity that provides networks for processing payments, such as credit card payments.

A merchant code may be received 506 from the payment network processor. The merchant code may comprise a proprietary merchant code created by the payment network processor. The credit card curator may have a first set of merchant codes stored in a database and may map the first set of merchant codes to a second set of merchant codes owned by the payment network processor. The second set of merchant codes may comprise the merchant code. In an embodiment, the merchant code may comprise a universal merchant category code. A universal merchant category code (also known as a universal merchant identifier or universal merchant code) includes a unique number or identifier that indicates a plurality of business types and types of goods or services that a company may provide. In an example, a universal merchant identifier includes all possible merchant codes. In another example, a universal merchant identifier includes a subset of all possible merchant codes.

A payment option may be identified 508 using an optimization algorithm and the merchant code. The payment option may be selected from a set of payment options. The optimization algorithm may use machine learning to identify the payment option. The optimization algorithm may use artificial intelligence to identify the payment option. For example, the optimization algorithm may identify a spending history. For example, if a user spends $200 on cellphone service every month, the optimization algorithm may select a credit card associated with an advantageous reward scheme for spending $200 on cellphone service and use the selected credit card to pay for the cellphone service every month. The optimization algorithm may train on a spending history. The optimization algorithm may train on redeeming points and/or rewards. The optimization algorithm may track and/or learn which type of points and/or rewards are preferred by a user (e.g., this user never uses air miles, etc.). The optimization algorithm may figure out how to achieve the most points and/or rewards for a user. The optimization algorithm may cause the points and/or rewards to automatically be redeemed.

At least a portion of the optimization algorithm may be running on the credit card. For example, at least a portion of the optimization algorithm may be running on a chip on the credit card. At least a portion of the optimization algorithm may be running on a blockchain environment. At least a portion of the optimization algorithm may be running on a cloud server. The payment option may comprise a second credit card. The second credit card may be associated with the merchant code. The payment option may comprise a digital wallet. The payment option may comprise a cryptocurrency wallet.

The purchase transaction may be completed 510 by applying the payment option. In various embodiments, applying the payment option may comprise using a primary account number (PAN) associated with the second credit card. Applying the payment option may comprise deducting digital credit from the digital wallet. Applying the payment option may comprise deducting cryptocurrency from the cryptocurrency wallet. Completing the transaction by applying the payment option may comprise transferring a balance to a second payment option.

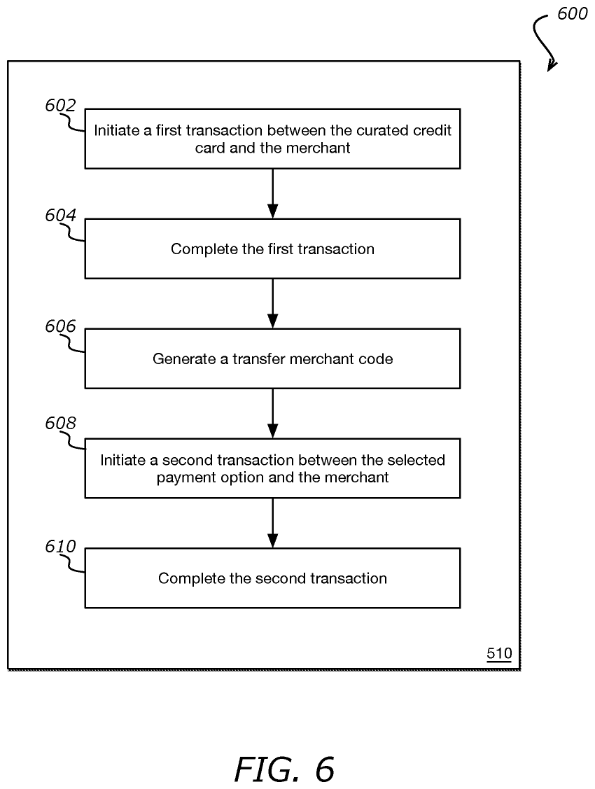

FIG. 6 illustrates an example process 600 for completing a transaction in accordance with various embodiments. In this example, additional steps of step 510 are described. In this example, a first transaction may be initiated 602 between the curated credit card and the merchant. This can include, for example, authorizing and settling using one or more payment processing techniques the first transaction between the curated credit card and the merchant. More specifically, the first transaction may be associated with a merchant code and a transaction amount. A transaction may be initiated using the merchant code and the transaction amount. The first transaction can be completed 604 between the curated credit card and the merchant using the one or more payment processing techniques known to those skilled in the art. A transfer merchant code can be generated 606 based on the initial merchant code. In an embodiment, the transfer merchant code can be the same as the initial merchant code. In an embodiment, the transfer merchant code can be mapped from the initial merchant code. In an embodiment, the transfer merchant code comprises a global merchant code. A second transaction can be initiated 608 between the curated credit card and the selected payment option based on the transaction amount, the transfer merchant code, and/or other factors described herein. The second transaction is completed 610 between the curated credit card and the selected payment option, wherein the first transaction is payable by the provider of the curated credit card and the second transaction is payable by a consumer associated with the selected payment option.

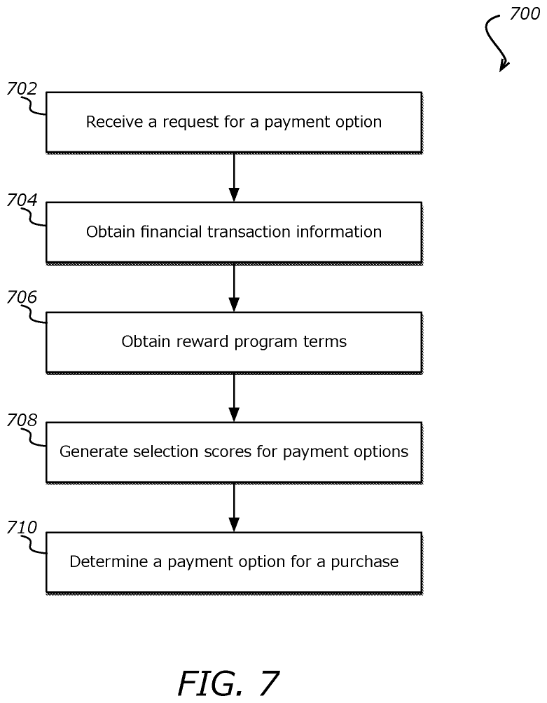

FIG. 7 illustrates an example process 700 for selecting a payment option to maximize the accumulation, exchange, and/or redemption of rewards in accordance with various embodiments. In this example, a request for a recommendation for at least one payment option from a plurality of payment options that maximize a reward criterion is received 702. In an embodiment, a reward criterion comprises a travel benefit, a cashback benefit, a flight benefit, a hotel benefit, a charitable contribution benefit, a return benefit, investment benefit to an investment account, a green benefit (e.g., a combination of investing and charity, including green investing, green charities, carbon credit, etc.), and the like. Goals might specify, for example, a trip to Paris for two, for five days, with business class airplane travel, and five-star accommodation, wherein the entire trip is paid by rewards points. The rewards can include bonus points, airline miles, reward points, hotel points, restaurant points, carbon offsets/credits or a combination thereof.

Financial transaction information associated with the consumer is obtained 704. The financial transaction information can include one of purchase transaction information from financial accounts associated with the consumer or reward points associated with reward programs associated with the consumer.

Reward program terms for a plurality of reward programs is obtained 706. In various embodiments, the reward programs can be associated with a payment option, and a reward program can specify, for example, a reward program bonus, an amount to spend within a time frame to receive the reward program bonus, and any other appropriate qualifying information. The payment options, in certain embodiments, can be associated with banking institution policies that specify eligibility requirements for qualifying for a corresponding payment option.

The financial transaction information, the reward program terms for the plurality of reward programs, and banking institution policies for corresponding payment options can be analyzed to generate 708 selection scores (e.g., a vector of scores) for potential payment options. A selection score, in an embodiment, quantifies a degree to which rewards earned through the use of a corresponding payment option account maximizes the user goal. In certain embodiments, a score is assigned to each payment option for purchases in each category. Some payment options have only one purchase category because all purchases made with the payment option earn the same rewards. Still, some payment options have multiple purchase categories, so that the use of a card for a purchase in a general category may have a low score, and the use of the card for a purchase in a particular category may have a higher score. In addition, particular card issuers may operate promotions for specific merchants or categories of merchants or may have ongoing relationships with specific merchants, so that the use of a particular card for a merchant associated with a promotion or a special relationship may earn points at a higher rate.

It should be noted that any number of scoring mechanisms may be implemented, such as a scoring mechanism maximizing rewards earned for one or more goals, a scoring mechanism assigning an actual cash value to such factors as interest costs and cashback rewards, and a cash equivalent value to reward points, with the cash value assigned to reward points being higher when the point total is near a level required to achieve the desired reward. The valuation assigned to reward points from different programs may vary. For example, reward points associated with a program regularly used by the consumer may be given a higher value.

The selection scores can be used to determine 710 a payment option when a purchase is contemplated. For example, when a purchase is contemplated, details of the purchase are analyzed and each payment option is scored, and the highest scoring card is recommended for the purchase. In certain embodiments, details of a user's location (e.g., geographic location or GPS location) can be used to identify nearby stores, which can be used to supplement details of a current purchase and/or otherwise be used to select a credit card for a purchase. In the situation a card not included in the portfolio would be useful to maximize rewards for at least one goal or reward criterion, a notification or other information can be provided to the user, where the information can include details about the card, rewards missed for not using the card, and the like.

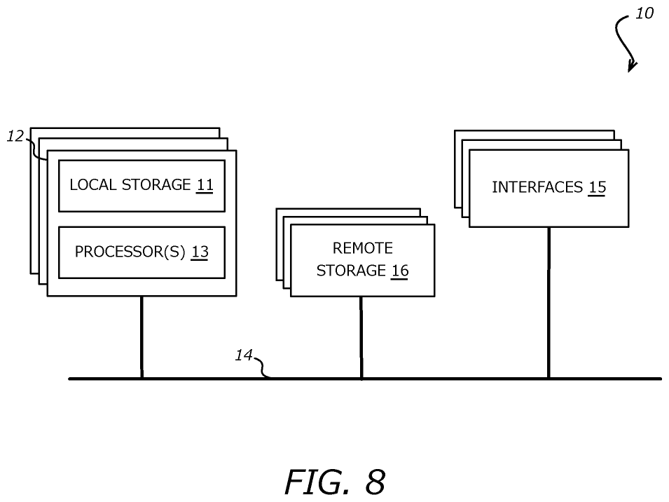

Referring now to FIG. 8, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 8 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memory storage, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

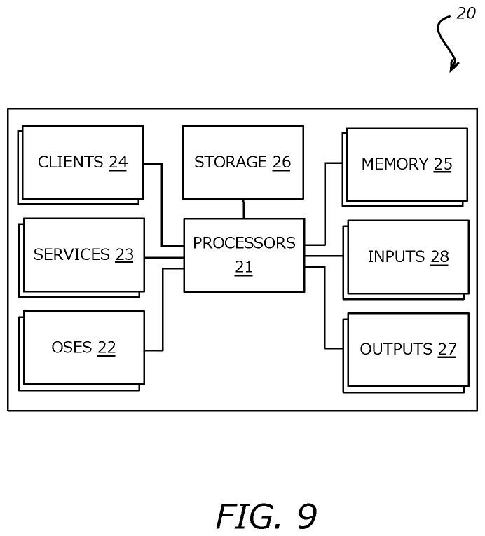

In some embodiments, systems may be implemented on a standalone computing system. Referring now to FIG. 9, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 22. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memory storage, or electrical storage device for storage of data in digital form (such as those described above, referring to FIG. 8). Examples of storage devices 26 include flash memory, magnetic hard drive, CD-ROM, and/or the like.

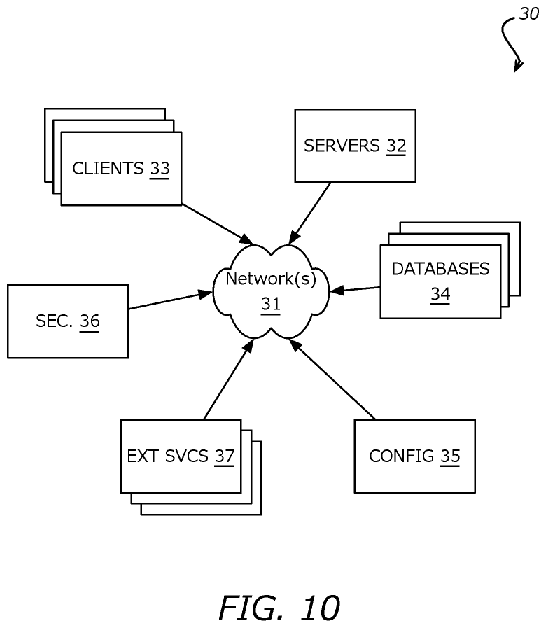

In some embodiments, systems may be implemented on a distributed computing network, such as one having any number of clients and/or servers. Referring now to FIG. 10, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a standalone computing system 20 such as that illustrated in FIG. 9. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

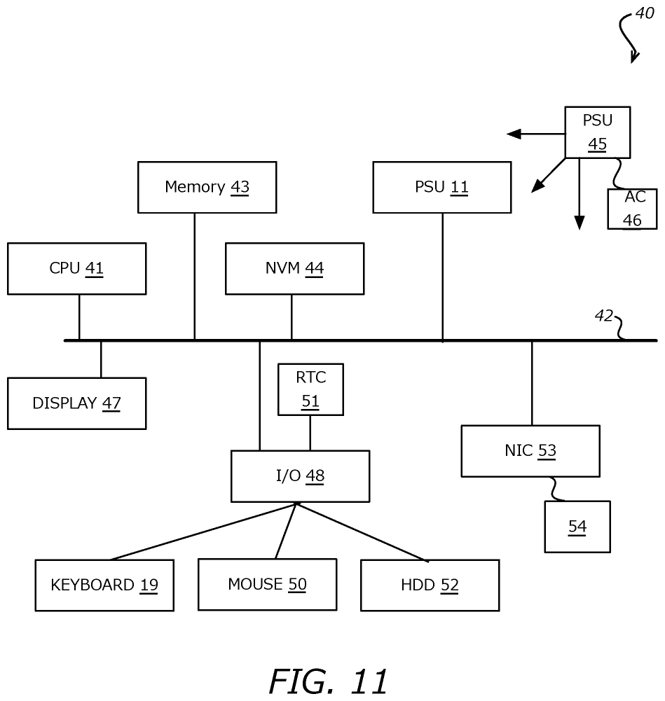

FIG. 11 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 19, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for collaborative text detection and recognition through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

Accordingly, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

What is claimed is:

1. A computing system, comprising:
a computing device processor; and
a memory device including instructions that, when executed by the computing device processor, enables the computing system to:
receive a purchase transaction indication between a payment option curation account and a merchant, the purchase transaction indication associated with at least a merchant code and a transaction amount, the payment option curation account associated with a payment option curation card,
initiate a first transaction based on the purchase transaction indication by using an identifier associated with the payment option curation account that is issued by a payment network processor, the identifier being associated with at least one other payment option,
receive the merchant code from the payment network processor by using the purchase transaction indication,
identify a set of payment options associated with the payment option curation account,
select a payment option from the set of payment options by using an optimization algorithm and the merchant code to identify a selected payment option,
complete the first transaction between the payment option curation account and the merchant,
generate a transfer merchant code based on the merchant code,
initiate a second transaction between the payment option curation account and the selected payment option based on the transaction amount and the transfer merchant code, and
complete the second transaction between the payment option curation account and the selected payment option, wherein the first transaction is payable by the payment network processor and the second transaction is payable by a consumer associated with the selected payment option.

2. The computing system of claim 1, wherein the first transaction is one of a point-of sale purchase transaction or a digital purchase transaction.

3. The computing system of claim 1, wherein the purchase transaction indication is an indication from one of a credit card swipe, a credit card tap, a reading of a credit card chip, a near-field communication (NFC) chip, or a digital wallet.

4. The computing system of claim 1, wherein the purchase transaction indication comprises location data.

5. The computing system of claim 4, wherein the location data indicates a proximity to the merchant.

6. The computing system of claim 1, wherein the identifier is a primary account number (PAN).

7. The computing system of claim 1, wherein individual payment options of the set of payment options comprises a credit card number and an identifier associated with a third-party, the individual payment options being issued by a banking institution.

8. The computing system of claim 1, wherein the merchant code comprises one of a global merchant identifier or a proprietary merchant code created by the payment network processor.

9. The computing system of claim 1, wherein the optimization algorithm uses machine learning to identify the selected payment option.

10. The computing system of claim 1, wherein at least a portion of the optimization algorithm is executing on one of the payment option curation card, a blockchain environment, or a server.

11. The computing system of claim 1, wherein the set of payment options comprises one of a digital wallet, cryptocurrency wallet, a credit card account, a debit card account.

12. The computing system of claim 1, wherein completing the second transaction includes one of using a primary account number (PAN associated with the selected payment option, deducting digital credit from a digital wallet, deducting cryptocurrency from a cryptocurrency wallet, deducting the transaction amount from a checking or savings account.

13. A computer-implemented method, comprising:
receiving a purchase transaction indication between a payment option curation account and a merchant, the purchase transaction indication specifying at least a merchant code and a transaction amount, the payment option curation account associated with a payment option curation card,
initiating a first transaction based on the purchase transaction indication by using an identifier associated with the payment option curation account that is issued by a payment network processor, the identifier being associated with at least one other payment option,
receiving the merchant code from the payment network processor by using the purchase transaction indication,
identifying a set of payment options associated with the payment option curation account,
selecting a payment option from the set of payment options by using an optimization algorithm and the merchant code to identify a selected payment option,
completing the first transaction between the payment option curation account and the merchant,
generating a transfer merchant code based on the merchant code,
initiating a second transaction between the payment option curation account and the selected payment option based on the transaction amount and the transfer merchant code, and
completing the second transaction between the payment option curation account and the selected payment option, wherein the first transaction is payable by the payment network processor and the second transaction is payable by a consumer associated with the selected payment option.

14. The computer-implemented method of claim 13, wherein the first transaction is one of a point-of sale purchase transaction or a digital purchase transaction.

15. The computer-implemented method of claim 13, wherein the purchase transaction indication comprises location data, and wherein the location data indicates a proximity to the merchant.

16. The computer-implemented method of claim 13, wherein the purchase transaction indication is an indication from one of a credit card swipe, a credit card tap, a reading of a credit card chip, a near-field communication (NFC) chip, or a digital wallet.

17. A non-transitory computer readable storage medium storing instructions that, when executed by at least one processor of a computing system, causes the computing system to:
receive a purchase transaction indication between a payment option curation account and a merchant, the purchase transaction indication specifying at least a merchant code and a transaction amount, the payment option curation account associated with a payment option curation card,
initiate a first transaction based on the purchase transaction indication by using an identifier associated with the payment option curation account that is issued by a payment network processor, the identifier being associated with at least one other payment option,
receive the merchant code from the payment network processor by using the purchase transaction indication,
identify a set of payment options associated with the payment option curation account,
select a payment option from the set of payment options by using an optimization algorithm and the merchant code to identify a selected payment option,
complete the first transaction between the payment option curation account and the merchant,
generate a transfer merchant code based on the merchant code,
initiate a second transaction between the payment option curation account and the selected payment option based on the transaction amount and the transfer merchant code, and
complete the second transaction between the payment option curation account and the selected payment option, wherein the first transaction is payable by the payment network processor and the second transaction is payable by a consumer associated with the selected payment option.

18. The non-transitory computer readable storage medium of claim 17, wherein the instructions, when executed by the at least one processor, further enables the computing system to:
analyze the purchase transaction indication to determine categories for anticipated purchases; and
generate a list of preferred credit card accounts for use based on the categories for the anticipated purchases.

19. The non-transitory computer readable storage medium of claim 17, wherein the instructions, when executed by the at least one processor, further enables the computing system to:
determine a geographic location of the merchant;
identify a business at which the first transaction is being undertaken based on the geographic location; and
identify a payment option that maximizes rewards when used to complete the first transaction.

20. The non-transitory computer readable storage medium of claim 17, wherein the merchant code includes one of a universal merchant code or a dynamic merchant code.
